(19) United States
(12) Patent Application Publication
(10) Pub. No.: US 2007/0287817 A1
(43) Pub. Date: Dec. 13, 2007

(54) Mixture Composition Containing Unsaturated Carboxylic Acid and Alkene Ether Derivative Based Copolymers and Copolymers and Terpolymers Containing Sulfo Groups and Use Thereof

(76) Inventors: Markus Maier, Trostberg (DE); Ulrike Kastner, Trostberg (DE); Werner Strauss, Trostberg (DE); Konrad Wutz, Trostberg (DE); Gregor Keilhofer, Tacherting (DE); Andrea Fenchl, Wasserburg (DE)

Correspondence Address: FULBRIGHT & JAWORSKI, LLP, 666 FIFTH AVE, NEW YORK, NY, 10103-3198, US

(21) Appl. No.: 11/631,453

(22) PCT Filed: Jun. 30, 2005
(86) PCT No.: PCT/EP05/07088

§ 371 Date: Feb. 15, 2007

(30) Foreign Application Priority Data
Jul. 3, 2004 (DE) 102004032399.2

(51) Int. Cl. C08F 20/06

(52) U.S. Cl. 526/320; 526/333

(57) ABSTRACT

The invention relates to a mixture composition having dispersing properties, containing copolymers based on unsaturated mono or dicarboxylic acid derivatives and oxyalkylene ethers as component I and water-soluble copolymers and terpolymers containing sulfo groups having an average molecular weight of 50 000-20 000 000 g/mol as component II. By combining both components, which can be respectively characterized by four different structural units, it is possible to obtain mixture compositions which can, more particularly, be used as dispersing agents for organic and/or inorganic pigments and fillers, in addition to known applications in the field of structural chemistry. In the field of structural chemistry, the mixture compositions are suitable for use on account of the dispersing properties thereof, particularly in ceramic systems and in water-based painting and coating systems. Independently of the dispersing effect thereof, the described mixture compositions are also excellent solvents, wherein they can be used more particularly as casein substitutes, even in self-levelling gap-filling materials and trowelling compounds by virtue of the stabilizing effect thereof. The inventive mixture composition combines known positive properties of components I and II and can be used in new fields of application, even in the non-structural chemistry field.

Mixture composition containing copolymers based on unsaturated carboxylic acid and alkenyl ether derivatives and copolymers and terpolymers containing sulpho groups and use thereof.

### DESCRIPTION

The present invention relates to a mixture composition having dispersing properties, containing firstly copolymers based on unsaturated mono or dicarboxylic acid derivatives and oxyalkylene glycol alkenyl ethers as component I and secondly copolymers and terpolymers containing sulpho groups as component II, and also to the use of this mixture composition.

The two main components of the claimed mixture composition, components I and II, are each sufficiently well known from the prior art. German Offenlegungsschrift DE 199 26 611 thus describes copolymers according to component I which are excellent additives for aqueous suspensions of inorganic and organic solids based, in particular, on mineral or bituminous binders such as cement, gypsum, lime, anhydrite or other calcium sulphate-based building materials. However, the described copolymers can equally be used as additives for aqueous suspensions based on pulverulent dispersion binders. The use of these copolymers in the fields of ceramic materials, refractory materials and oilfield building materials has also previously been described.

German Offenlegungsschrift 100 37 629 and document DE 103 48 502.3, which has not yet been published, describe the copolymers and terpolymers according to main component II. DE 100 37 629 attributes to copolymers according to main component II excellent water-retaining properties even at relatively high application temperatures, the copolymers also being capable of imparting outstanding application-related properties, both in the processing and in the set or dried state, to pigment-containing paints, renders, adhesive mortars, fillers, joint fillers, air placed concrete, underwater concrete, oil well cements and other products in building chemistry. The polymers described in said documents are distinguished, in particular, in that they allow the thickening properties of the building material mixtures to be purposefully adjusted via the chain length, charge density, amphiphilia and hydrophobic side chains even at a high concentration of electrolytes. In concrete, flow screeds and other free-flowing gap-filling material, the copolymers according to DE 100 37 629, which are added in small amounts, act as stabilisers and anti-segregation agents.

German patent application 103 48 502.3, which builds on DE 100 37 629 but has not yet been published, has previously described water-soluble copolymers and terpolymers which contain sulpho groups and are also ideal for imparting stabilising properties to aqueous building material systems and water-based painting and coating systems. Applications said to be particularly suitable in this connection include aqueous building material systems containing cement, lime, gypsum and anhydrite as hydraulic binders.

In the development of the copolymers corresponding to main component I, the principal object was to provide new compounds which maintain the processability of high-concentration building material mixtures for long service periods even when added in small amounts, allowing increased strength to be achieved simultaneously when the building material has set even if the water/binder ratio is markedly lowered.

For the development of the copolymers and terpolymers corresponding to main component II of the present invention, the principal aim was pronounced effectiveness at comparatively high temperatures. Equally, these polymers are to display uniform thickening properties even in the case of high electrolyte contents, to be preparable in a simple and easily reproducible manner and finally to impart outstanding application-related properties during processing, but also when set or dried, to the building material and painting systems to which they are added.

As it has been possible to fulfil each statement of object for the two polymer groups described, and additional positive properties have also been demonstrated in practice, it would now be desirable both to combine in a single composition the respective positive properties of the polymers described and to extend the respective advantages in known fields of application to other areas.

The object of the present invention is therefore to provide a mixture composition which, on the basis of known copolymers and terpolymers, both has dispersing properties for inorganic and organic solids, in particular solids based on mineral or bituminous binders, and positively influences the viscosity of building material mixtures, wherein, in particular, it should be possible to stabilise the building material mixtures even when they are added in small amounts. In addition, this mixture composition should also be simply and economically accessible.

This object was achieved by a mixture composition having dispersing properties containing I) copolymers based on unsaturated mono or dicarboxylic acid derivatives and oxyalkylene glycol alkenyl ethers and II) water-soluble copolymers and terpolymers containing sulpho groups and having a number average molecular weight of from 50,000 to 20,000,000 g/mol.

It has surprisingly been found that this mixture composition not only has the requisite product properties but also covers a range of applications extending beyond the possible uses of the individual components. The mixture composition claimed can thus not only be used as a dispersing agent in structural chemistry applications, but is also generally capable of dispersing organic and inorganic pigments and fillers. In the field of structural chemistry, the possible uses of the mixture composition according to the invention also extend beyond the known use as an additive for aqueous building material systems, as the mixture compositions containing components I) and II) have outstanding plasticizing and markedly stabilising properties, but are also capable of replacing previously known flow promoting additives such as, for example, casein, allowing both effectiveness and processing to be increased by a high degree. The sum of the effects achievable using the mixture composition according to the invention thus exceeds, in a broad range of applications, that to be expected from the combination, which is in fact obvious, of the individual components; this could not have been predicted to this extent.

Component I of the mixture composition corresponding to the present invention contains at least 3, but preferably 4, structural groups a), b), c) and d). The first structural group a) is a mono or dicarboxylic acid derivative having the general formula Ia, Ib or Ic.

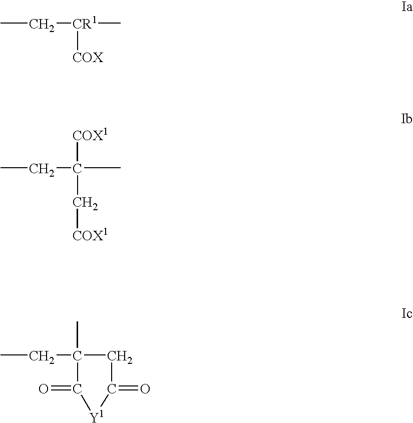

In the case of monocarboxylic acid derivative Ia, R¹ represents hydrogen or an aliphatic hydrocarbon radical containing 1 to 20 carbon atoms, preferably a methyl group. X¹ in structures Ia and Ib represents —OMₐ¹ and/or —O—(CₘH₂ₘO)ₙ—R² or —NH—(CₘH₂ₘO)ₙ—R² wherein M¹, a, m, n and R² have the meaning given above:

M¹ represents hydrogen, a monovalent or divalent metal cation, ammonium, an organic amine radical and a=½ or 1, depending on whether M¹ is a monovalent or divalent cation. The organic amine radicals used are preferably substituted ammonium groups derived from primary, secondary or tertiary C₁₋₂₀ alkylamines, C₁₋₂₀ alkanolamines, C₅₋₈ cycloalkylamines and C₈₋₁₄ arylamines. Examples of the corresponding amines include methylamine, dimethylamine, trimethylamine, ethanolamine, diethanolamine, triethanolamine, methyldiethanolamine, cyclohexylamine, dicyclohexylamine, phenylamine, diphenylamine, in the protonated (ammonium) form. For M¹, sodium, potassium, calcium and magnesium are preferred monovalent or divalent metal ions.

R² represents hydrogen, an aliphatic hydrocarbon radical containing 1 to 20 carbon atoms, a cycloaliphatic hydrocarbon radical containing 5 to 8 carbon atoms, an aryl radical containing 6 to 14 carbon atoms which can optionally also be substituted, m=2 to 4 and n=0 to 200. The aliphatic hydrocarbon radicals can in this case be linear or branched and saturated or unsaturated. Preferred cycloalkylradicals are cyclopentyl or cyclohexyl radicals and preferred aryl radicals are phenyl or naphthyl radicals which can, in particular, also be substituted by hydroxyl, carboxyl or sulphonic acid groups.

Alternatively or additionally to the dicarboxylic acid derivative according to formula Ib, structural group a) (mono or dicarboxylic acid derivative) can also be in cyclic form corresponding to formula Ic, wherein Y═O (acid anhydride) or NR² (acid imide), NR² have the meaning given above.

The second structural group, structural group b), corresponds to formula II 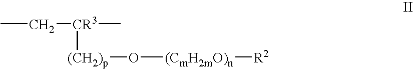
and is derived from oxyalkylene glycol alkenyl ethers, in which m, n and R² have the meaning given above. R³ in turn represents hydrogen or an aliphatic hydrocarbon radical containing 1 to 5 carbon atoms which can also be linear or branched and also unsaturated. p can assume values of between 0 and 3.

According to the preferred embodiments, in formulae Ia, Ib and II m=2 and/or 3, so the groups are polyalkylene oxide groups derived from polyethylene oxide and/or polypropylene oxide. In a further preferred embodiment, p in formula II represents 0 or 1, i.e. vinyl and/or alkyl polyalkoxylates.

The third structural group, structural group c), corresponds to formula IIIa or IIIb

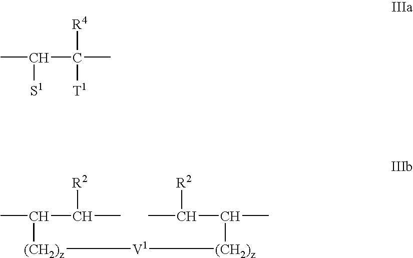

In formula IIIa, R⁴ can be H or CH₃, depending on whether the derivatives are acrylic or methacrylic acid derivatives. S¹ can in this case represent —H, —COOMₐ¹ or —COOR⁵, wherein a and M¹ have the meaning given above and R⁵ can be an aliphatic hydrocarbon radical containing 3 to 20 carbon atoms, a cycloaliphatic hydrocarbon radical containing 5 to 8 carbon atoms or an aryl radical containing 6 to 14 carbon atoms. The aliphatic hydrocarbon radical can also be linear or branched, saturated or unsaturated. Preferred cycloaliphatic hydrocarbon radicals are, in turn, cyclopentyl or cyclohexyl radicals and preferred aryl radicals are phenyl or naphthyl radicals. If T¹=—COOR⁵, S¹═COOMₐ or —COOR—⁵. If T¹ and S¹═COOR⁵, the corresponding structural groups are derived from dicarboxylic acid esters.

In addition to these ester structural units, structural groups c) can also have other hydrophobic structural elements, including polypropylene oxide or polypropylene oxide/polyethylene oxide derivatives comprising

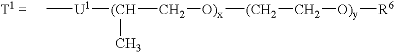

In this case x assumes a value of from 1 to 150 and y of from 0 to 15. The polypropylene oxide (polyethylene oxide) derivatives can in this case be linked via a grouping U¹ to the ethyl radical of structural group c) corresponding to formula IIIa, wherein U¹=—CO—NH—, —O— or —CH₂—O—. These are the corresponding amide, vinyl or allyl ethers of the structural group corresponding to formula IIIa. R⁶ can in this case, in turn, be R² (see above for the meaning of R²) or 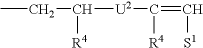
wherein U²=—NH—CO—, —O—, or —OCH₂— and S¹ has the above-described meaning. These compounds are polypropylene oxide (polyethylene oxide) derivatives of the bifunctional alkanol compounds corresponding to formula IIIa.

As a further hydrophobic structural element, the compounds corresponding to formula IIIa can contain polydimethylsiloxane groups, corresponding in schematic formula IIIa to T¹=−W¹−R⁷.

In this case W¹ represents 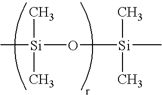
(referred to hereinafter as the polydimethylsiloxane grouping), R⁷ can=R² and r can in this case assume values of from 2 to 100.

The polydimethylsiloxane grouping can be bound not only directly to the ethyl radical but also via the groupings —CO—[NH—(CH₂)₃]ₛ—W¹—R⁷ or —CO—O(CH₂)_{z}—W¹—R⁷
wherein R⁷ preferably represents ═R² and s=1 or 2 and z=0 to 4. R⁷ can also represent

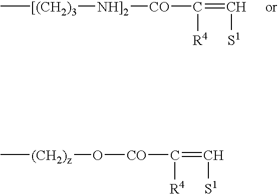

These are the corresponding difunctional ethylene compounds corresponding to formula IIIa which are linked together via the corresponding amide or ester groupings and wherein only one ethylene group has been copolymerised.

The same applies to the compounds according to formula IIIa comprising T¹=(CH₂)z-V¹(CH₂)_{z}—CH═CH—R² wherein z=0 to 4, V¹ can be either a polydimethylsiloxane radical W¹ or a —O—CO—C₆H₄—CO—O— radical and R² has the meaning given above. These compounds are derived from the corresponding dialkenyl phenyl dicarboxylic acid esters or dialkenyl polydimethylsiloxane derivatives.

In the scope of the present invention, it is also possible for not just one but rather both ethylene groups of the difunctional ethylene compounds to have been copolymerised. This corresponds substantially to the structural groups corresponding to formula IIIb 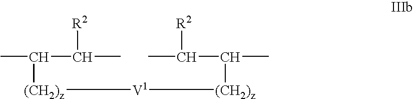
wherein R², V¹ and z are as defined above.

The fourth structural group, structural group d), is derived from an unsaturated dicarboxylic acid derivative of general formula IVa and/or IVb 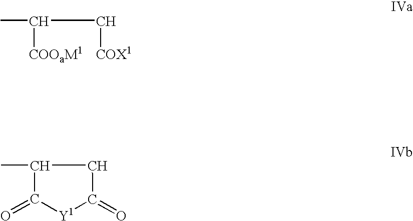
wherein a, M¹, X¹ and Y¹ are as defined above.

Copolymers I preferably contain 51 to 95 mol % of structural groups of formula Ia and/or Ib and/or Ic, 1 to 48.9 mol % of structural groups of formula II, 0.1 to 5 mol % of structural groups of formula IIIa and/or IIIb and 0 to 47.9 mol % of structural groups of formula IVa and/or IVb.

Component I particularly preferably contains 55-75 mol % of structural groups of formula Ia and/or Ib, 19.5-39.5 mol % of structural groups of formula II, 0.5 to 2 mol % of structural groups of formula IIIa and/or IIIb and 5 to 20 mol % of structural groups of formula IVa and/or IVb.

According to a preferred embodiment, the mixture composition according to the invention additionally contains, with respect to component I, up to 50 mol %, in particular up to 20 mol %, based on the Total of structural groups of formulae I, II, III and IV, of structures based on monomers based on, inter alia, vinyl or (meth)acrylic acid derivatives such as styrene, α-methyl styrene, vinyl acetate, vinyl propionate, ethylene, propylene, isobutene, hydroxyalkyl (meth)acrylate, acrylamide, methacrylamide, N-vinyl pyrrolidone, allylsulphonic acid, methallylsulphonic acid, vinylsulphonic acid, vinylphosphonic acid, AMPS, methyl methacrylate, methyl acrylate, butyl acrylate, allylhexyl acrylate.

The number of recurring structural units in copolymers I is not restricted. However, the adjustment of average molecular weights of 1,000 to 100,000 g/mol has been found to be particularly advantageous.

According to the invention, copolymers and terpolymers II contain four structural groups a), b), c) and/or d).

The first structural group a) is a substituted acrylic or methacrylic derivative containing sulpho groups of formula I: 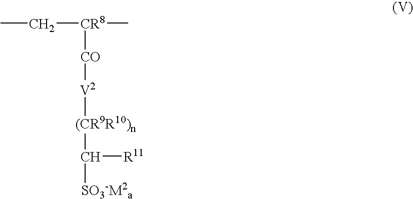
wherein R⁸=hydrogen or methyl, R⁹, R¹⁰ and R¹¹=hydrogen, aliphatic hydrocarbon radical containing 1 to 6 carbon atoms, phenyl radical optionally substituted by methyl groups, V²=NH or oxygen and M²=hydrogen, a monovalent or divalent metal cation, ammonium or an organic amine radical, n=1 to 5 and a=½ or 1. The monovalent or divalent metal cation used is preferably a sodium, potassium, calcium or magnesium ion. The organic amine radicals used are preferably substituted ammonium groups derived from primary, secondary or tertiary C₁ to C₂₀ alkylamines, C₁ to C₂₀ alkanolamines, C₅ to C₈ cycloalkylamines and C₆ to C₁₄ arylamines. Examples of corresponding amines include methylamine, dimethylamine, trimethylamine, ethanolamine, diethanolamine, triethanolamine, cyclohexylamine, dicyclohexylamine, phenylamine and diphenylamine in the protonated ammonium form.

Structural group a) of component II is derived primarily from monomers such as 2-acrylamido-2-methylpropane sulphonic acid, 2-methacrylamido-2-methylpropane sulphonic acid, 2-acrylamidobutane sulphonic acid, 3-acrylamido-3-methylbutane sulphonic acid, 2-acrylamido-2,4,4-trimethylpentane sulphonic acid, 3(methacryloyl-oxy)-propane sulphonic acid. Particularly preferred is 2-acrylamido-2-methylpropane sulphonic acid (AMPS) or a salt thereof.

Up to 50 mol % of structural groups a) of component II can optionally be replaced by further sulphonic acid group-containing structural units derived from methallyl sulphonic acid or allyl sulphonic acid monomers.

In component II, the second structural group, structural group b), corresponds to formula VIa) and/or VIb): 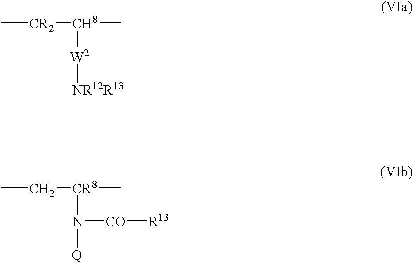
wherein W²=—CO—, CO—O—(CH₂)ₓ—, CO—NR⁹—(CH₂)ₓ—
x=1 to 6 and
R⁸ and R⁹ are as defined above.

R¹² and R¹³, independently of each other, represent hydrogen, an optionally substituted aliphatic hydrocarbon radical containing 1 to 20 carbon atoms, a cycloaliphatic hydrocarbon radical containing 5 to 8 carbon atoms or an aryl radical containing 6 to 14 carbon atoms. These radicals can optionally be substituted by hydroxyl, carboxylic or sulphonic acid groups.

In formula VIb), Q represents hydrogen or —CHR¹²R¹⁴. If Q≠H, R¹² and R¹³ can also jointly represent in structure VIb) a —CH₂—(CH₂)_{y} methylene group wherein y=1 to 4 which form, on inclusion of the radical of formula VIb) 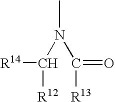
a five to eight-membered heterocyclic ring. R¹⁴ can represent a hydrogen atom, a C₁ to C₄ alkyl radical, a carboxylic acid or a carboxylate group —COOM²a, M² and a having the meaning given above.

Monomers forming structure VIa) preferably include the following compounds: acrylamide, methacrylamide, N-methylacrylamide, N—N-dimethylacrylamide, N-ethylacrylamide, N-cylcohexylacrylamide, N-benzylacrylamide, N-methylolacrylamide, N-tertiary butylacrylamide, etc. Examples of monomers as a base for structure VIb) include N-methyl-N-vinyl formamide, N-methyl-N-vinyl acetamide, N-vinyl pyrrolidone, N-vinyl caprolactam, N-vinylpyrrolidone-5-carboxylic acid.

The third structural group, structural group c) of component II, corresponds to formulae VIIa and/or VIIb. 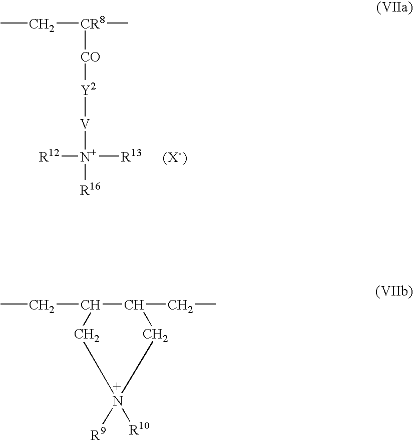
wherein
Y²=O, NH or NR¹²
V²=(CH₂)ₓ—,

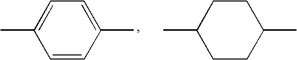

R¹⁵=R¹²bzw. R¹³, —(CH₂)ₓ—SO₃^{e}M²ₐ, 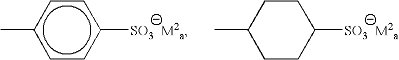
X²=halogen (preferably Cl, Br), C₁ to C₄ alkyl sulphate (preferably methyl sulphate) or C₁ to C₄ alkyl sulphonate and
R⁸, R⁹, R¹⁰, R¹², R¹³ and x are as defined above.

Monomers forming structure (VIa) preferably include the following compounds: [2-(acryloyloxy)-ethyl]-trimethyl-ammonium chloride, [2-(acryloylamino)-ethyl]-trimethyl-ammonium chloride, [2-(acryloyloxy)-ethyl]-trimethyl-ammonium methosulphate, [2-(methacryloyl-oxy)-ethyl]trimethyl ammonium chloride or methosulphate, [3-(methacryloylamino)-propyl]-trimethyl ammonium chloride, N-(3-sulphopropyl)-N-methacryloxyethyl-N′-N-dimethyl-ammonium-betaine, N-(3-sulphopropyl)-N-methyacrylamidopropyl-N,N-dimethyl-ammonium-betaine and 1-(3-sulphopropyl)-2-vinyl-pyridinium-betaine.

Examples of monomers as a base for structure VIIb) include N,N-dimethyl-diallyl-ammonium chloride and N,N-diethyl-diallyl-ammonium chloride.

The fourth structural group, structural group d) of component II, corresponds to formula VIII 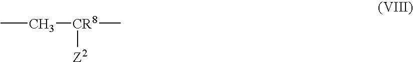
wherein
Z²=—COO(CₘH₂ₘO)ₙ—R¹⁶, —(CH₂)ₚ—O(CH₂CHW³O)ᵣ(CₘH₂ₘO)ₙR¹⁶
W³=H, CH₃, C₂H₅
r=0 to 100
R¹⁶=H, 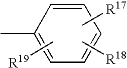
wherein at least one radical R¹⁷, R¹⁸ and/or R¹⁹ must be represented, and an unsaturated or saturated, linear or branched, aliphatic hydrocarbon radical containing 1 to 40 carbon atoms.
R¹⁷=H, C₁-C₂ alkyl, phenyl, benzyl, C₁ to C₆ alkoxy, halogen (F, Cl, Br, I), cyano, —COOH, —COOR¹², —CO—NH₂, —OCOR¹²
R¹⁸=an arylalkyl group containing a C₁-C₁₂ alkyl and C₆-C₁₄ aryl radical
m=2 to 4
n=0 to 200
p=0 to 20
and R⁸ and R¹² are as defined above.

Preferred monomers forming structure VIII include tristyryl polyethylene glycol-1100-methacrylate, behenyl polyethylene glycol-1100-methacrylate, tristyryl polyethylene glycol-1100-acrylate, tristyryl polyethylene glycol-1100-monovinyl ether, behenyl polyethylene glycol-1100-monovinyl ether, phenyl triethylene glycol acrylate, tristyryl polyethylene glycol-1100-vinyloxy-butyl ether, behenyl polyethylene glycol-1100-vinyloxy butyl ether, tristyryl polyethylene glycol-block-propylene glycol allyl ether, behenyl polyethylene glycol-block-propylene glycol allyl ether, etc.

Copolymers and terpolymers II preferably consist of from 3 to 96 mol % of structural group a), from 3 to 96 mol % of structural group b), up to 75 mol % of structural group c) and/or up to 50 mol % of structural group d).

The mixture composition claimed particularly preferably contains polymers II containing from 30 to 80 mol % of a), from 5 to 55 mol % of b), from 2 to 30 mol % of c) and/or from 0.2 to 15 mol % of d).

The number of repeating structural elements in copolymers and terpolymers II contained in accordance with the invention is not restricted and is very markedly dependent on the respective application. It has, however, been found to be advantageous to adjust the number of structural units in such a way that the copolymers and terpolymers have a number average molecular weight of from 50,000 to 10,000,000.

In the scope of the present invention, it has been found to be particularly advantageous if the molar content of structural group c) of component II is at least 5 mol % lower than the molar content of structural group a).

In the scope of the present invention, it is also possible for up to 50 mol % of structural groups a), b) or c) in component II to be replaced by structural units derived from acrylamide or N,N-dimethylacrylamide monomers.

The present invention also encompasses a variation of the claimed mixture composition wherein component II additionally contains from 0.0001 to 50 mol % of structural groups e) derived from polymerisable monoolefinic, diolefinic and triolefinic compounds. Particularly preferred in this regard are diolefinic compounds consisting of diacrylate or dimethylacrylate esters. Trimethylolpropane, triacrylate and triallyl isocyanate are preferred triolefinic monomers and acrylic and vinyl derivatives are preferred monoolefinic compounds.

In the scope of the present invention, it is also possible for component II additionally to contain up to 50 mol %, in particular up to 20 mol %, based on the Totals of structural groups a), b), c) or d) and optionally e), of a further structural group, structural group f), of formula (IX). 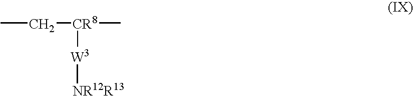
wherein
W⁴=—CO—O—(CH₂)_{q}—, —CO—NR⁹—(CH₂)_{q}—
q=1 to 6 and
R⁸, R⁹, R¹² and R¹³ are as defined above.

Monomers forming structure (IX) preferably include the following compounds: [3-(methacryloylamino)-propyl]-dimethylamine, [3-(acryloylamino)-propyl]-dimethylamine, [2-(methacryloyl-oxy)-ethyl]-dimethylamine, [2-(acryloyl-oxy)-ethyl]-dimethylamine, [2-(methacryloyl-oxy)-ethyl]-diethylamine, [2-(acryloyl-oxy)-ethyl]-diethylamine, etc.

In the scope of the present invention, it is also possible for up to 50% of structural group a) of component II to be replaced by a sulphonic acid-containing betaine monomer of formula (X). 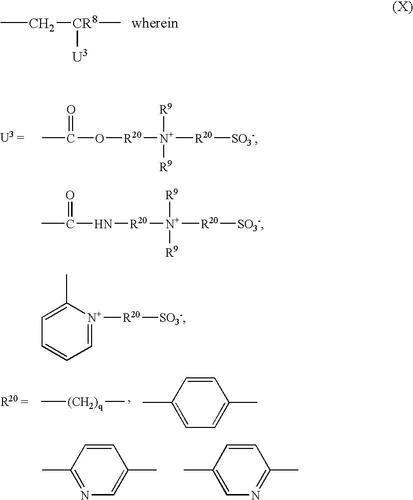
R⁸, R⁹ and q are as defined above.

Monomers forming structure (X) preferably include the following compounds: N-(3-sulphopropyl)-N-methacryloxyethyl-N′-N-dimethyl-ammonium-betaine, N-(3-sulphopropyl)-N-methacrylamidopropyl-N,N-dimethyl-ammonium-betaine and 1-(3-sulphopropyl)-2-vinyl-pyridinium-betaine. Although these monomers also contain a cationic structural group, this does not adversely affect the air void stability in the application.

The incorporation of small amounts of crosslinking agents can, if appropriate, provide component II with a slightly branched or crosslinked structure. Examples of crosslinking agent components of this type include triallylamine, triallymethylammonium chloride, tetrallylammonium chloride, N,N′-methylene-bis-acrylamide, triethylene glycol-bis-methacrylate, triethylene glycol-bis-acrylate, polyethylene glycol(400)-bis-methacrylate and polyethylene glycol(400)-bis-acrylate. These compounds may be used only in amounts such that water-soluble copolymers and terpolymers are still obtained as component II. In general, the concentration will rarely be above 0.1 mol %, based on the Totals of structural groups a) to g), although a person skilled in the art can easily determine the maximum usable amount of crosslinking agent component.

The present invention gives particular preference to a mixture composition in viscous and, particularly preferably, in liquid form.

The present invention does not in any way restrict the preparation of the mixture composition and, in particular, of components I and II contained therein.

The copolymers according to component I are thus conventionally prepared in accordance with the process as described in DE-OS 199 26 611. The copolymers and terpolymers according to component II are prepared, for example, using the process according to DE-OS 100 37 629. They are normally prepared, in a manner known per se, by linkage of the monomers forming structures a) to d) by radical, ionic or complex coordination substance, solution, gel, emulsion, dispersion or suspension polymerisation. As the products must always be water-soluble polymers, polymerisation in the aqueous phase, polymerisation in inverse emulsion or polymerisation in inverse suspension is preferred.

Polymer components I and II, which can be prepared using these described processes or any other suitable processes, are then conventionally added to a basic composition. However, they can also simply be mixed in advance in the desired weight ratio and added as a premix to a basic composition, thus also allowing the mixture composition according to the invention to be achieved. The mixture composition advantageously contains from 0.05 to 50% by weight of component I and from 0.01 to 10% by weight of component II, wherein these components should be in solid form.

The present invention thus encompasses not only a mixture composition containing components I and II in addition to other components, but also a mixture composition containing exclusively the two components, components I and II, this then being a typical premix.

As the present invention emphasizes the dispersing properties of the mixture composition, there is also claimed a corresponding variation in which the mixture composition contains, in addition to components I and II, organic and/or inorganic pigments and fillers, thus imparting advantageous properties thereto. In addition to the mixture composition itself, the present invention also claims the use thereof, preference being given to fields of application which, in contrast to the previously known applications of individual components I and II, open up new intended uses.

One of the most important uses of the mixture composition is that as a dispersing agent for organic and/or inorganic pigments and fillers and, particularly preferably, in viscous preparations. This specific intended use, which focuses very generally on dispersing properties of the mixture composition, takes the present invention beyond the previously known intended applications of separated components I and II, the known structural chemistry applications in relation to the dispersing effect of the mixture composition obviously also being claimed in the present case as a particularly preferred field of use. In this connection, the mixture compositions according to the invention are, in particular, used as additives for aqueous building material systems, particularly preferably containing hydraulic binders such as cement, lime, gypsum, anhydrite, etc. Above all, the dispersing effect of the mixture composition claimed in structural chemistry and aqueous systems therefore also allows the stable and homogeneous introduction of organic and inorganic pigments such as, for example, iron oxides into compositions containing hydraulic binders such as, for example, concretes, mortars and trowelling compounds.

As coloured concretes and cements, for example in the form of coloured paving stones or entire concrete facades, have recently been used more and more frequently, there is an increasing need to add pigments, for example of the iron oxide type, either in powder form or in the form of a dispersion. Whereas wetting, which was usually insufficient, in the past made it difficult homogeneously to incorporate in particular pigment dusts but also pigment powders, the claimed mixture composition now allows stable dispersions which are ready for use to be provided, the claimed use of the mixture compositions additionally facilitating a much smaller pigment particle size in conjunction with a narrower particle size distribution. This allows both higher colour brilliance and lower pigment consumption. A further positive effect is that the pigments used exert a much lower adverse influence on the properties of the building material, so the adjusted starting formulations do not have to be separately adapted. In addition, the added pigments can be added more precisely, thus also allowing, for example, batch-free formulation of the building material in a plurality of individual steps, without the occurrence of colour variations between the individual building portions, or else, for example, only precisely precalculated surfaces being able to be treated.

Total, the proposed mixture compositions and the simultaneously dispersing and stabilising properties thereof, in particular for pigments and fillers, allow the homogeneous introduction of organic and/or inorganic pigments and fillers, in particular in liquid form, into viscous preparations, especially in the field of building materials, the fact that the stability of the dispersions prepared using the mixture compositions according to the invention is ensured over a relatively long period of time, of at least three months, without the dispersions prepared thereby separating out, being a significant advantage.

As stated hereinbefore, the field of application of the mixture composition according to the invention having dispersing properties is not only restricted to applications in structural chemistry but rather also permits fields of use inaccessible to the previous components I or II when used separately. The proposed mixture composition thus readily allows the preparation of functional systems and systems containing, for example, nanoparticles such as, for example, sun creams and UV protectants in general. These light protection agents can not only be used in the conventional manner as skin protection formulations, but rather also generally provide stable UV protection for, for example, wood-containing substrates and this obviously also applies to woody plants, so the protection agents are also suitable, for example, for agricultural use in apple plantations. However, functional systems of this type are also what are known as barrier layers, which are conventionally layer lattice silicates in plastics material films intended to reduce O₂ migration. However, systems of this type, for which the proposed mixture compositions are also suitable dispersing agents, are also magnetooptical systems. Further applications of the mixture composition according to the invention, which has a general dispersing effect, include abrasive pastes such as are also used in the form of slurries for what is known as chemical mechanical planarisation, but also surfaces having a catalytic effect and electrically conductive systems into which conductivity pigments are introduced using dispersants.

Nevertheless, structural chemistry applications are the main preferred field of use of the mixture composition having a dispersing effect. These applications also include ceramic systems and water-based painting and coating systems. The mixture composition can be introduced as a dispersing agent directly into a ceramic system or a water-based water and coating system, but also in the form of the described aqueous building material system to which the mixture composition according to the invention was initially added as a dispersing agent before the aqueous building material system thereby formulated passes into the ceramic system or the water-based painting and coating system.

The multiplicity of possible uses of the mixture composition according to the invention is also demonstrated outstandingly in the possible use thereof in general structural chemistry applications, independently of the dispersing effect thereof. The present invention therefore also claims a variation using the mixture composition according to the invention as an additive for aqueous building material systems, particular preference in turn being given to system containing a hydraulic binder such as, for example cement, lime, gypsum, anhydrite, etc. In this case, the mixture composition according to the invention has its positive effect, in particular, as a plasticizer, particular preference being given to a use in which the mixture composition has a simultaneously stabilising effect. Within this use variation, the present invention recommends the application of the claimed mixture composition in self-levelling levelling compounds materials and fillers, wherein a particularly positively pronounced effect can be achieved by using the mixture composition as a casein substitute, and the present invention gives special consideration to this.

As is known, casein has been used for a relatively long time as an additive in self-levelling cement containing fillers. In this case, casein, when added in conventional amounts, assumes the role of a plasticizer and acts to some extent as a stabiliser. Associated with this is both a viscosity-increasing effect and the reduction or prevention of sedimentation and separation. Conventional ready-to-use trowelling compounds usually contain, in addition to casein, a relatively small amount of an additional stabiliser, cellulose ether mainly being used. Casein-based levelling materials of this type, also referred to as SLUs or self-levelling underlayments, are marked by good flow properties, good “self-healing” and a pronounced tolerance to overwashing.

However, in addition to the aforementioned advantages, casein also has the drawbacks of being subjected, as a natural product, in particular to—seasonally determined—variations in quality, availability and price. It also tends to form mould and the preparation of cement systems requires relatively high shear rates in order to dissolve casein.

Although polycarboxylate-based copolymers, such as component I of the mixture composition according to the invention, have a very good dispersing effect, they do not have very markedly stabilising properties. Therefore, if these polycarboxylate ethers are used as plasticizers in combination with cellulose ethers as stabilisers in casein-based formulations, relatively large amounts of cellulose ether have to be used in order to obtain a stable blend. However, the addition of large amounts of cellulose ethers leads, in turn, to poor flow properties of the trowelling compound and the tolerance of the total system to overwatering is markedly impaired compared to casein-based compounds.

The mixture compositions according to the invention, on the other hand, as casein substitutes in cement systems such as, for example, fillers, have a markedly stabilising effect. In addition, they ensure a rapid dissolution rate and they display only slight or no thixotropic properties, so high, and constant slumps are formed over a relatively long period of time, of at least one hour. Finally, the claimed mixture compositions, as casein substitutes, delay neither cement hydration nor hardening, and there is also no discernible detrimental effect on the development of strength.

Total, the proposed mixture compositions, which contain component I and component II in combination, can be regarded as suitable casein substitutes having outstanding plasticizing and simultaneously stabilising properties.

Specifically, in the preferred use of the mixture composition according to the invention as a casein substitute in self-levelling levelling materials and fillers, it has been found to be beneficial if the mixing ratio of component I to component II is selected to be 0.01 to 99.99% by weight: 99.99 to 0.01% by weight.

The proposed combination of the copolymers, known from the prior art, according to component I and the copolymers and terpolymers according to component II in the mixture composition according to the invention has, in particular, led, in the fields of use also claimed, beyond the conventional range of the effects of the individual components to new and surprising properties rendering the mixture composition according to the invention suitable for new fields of application. They are thus not only excellent additives for aqueous suspensions of inorganic or organic solids based on mineral or bituminous binders or, very generally, ideally suited to the fields of ceramic materials, refractory materials and oilfield building materials, and they are also not restricted to the stabilising properties of the copolymers and terpolymers according to component II, which render them suitable, in particular when added in small amounts to pigment-containing paints, renders, adhesive mortars, fillers, joint fillers, air-placed concrete, flow concrete, self-sealing concrete, underwater concrete and underwater mortars, their outstanding dispersing properties also render them suitable, in most cases independently of the field of structural chemistry, for applications in the polymer- and plastics-processing industry, cosmetics, for electrochemical applications, but also for agriculture. However, the claimed mixture compositions are also particularly useful in the original field of application of component I and component II, namely the field of structural chemistry, as they impart in an outstanding manner, mainly as casein substitutes, the combination, usually regarded as problematic, of a good plasticizing effect and simultaneous pronounced stability.

The following examples will clarify the advantages of the mixture composition according to the invention and of the multiplicity of uses associated therewith.

### EXAMPLES

### 1. Pigment Dispersion

a) For the dispersion and stabilisation in water of iron oxide pigment powders used for dying building materials, mixtures were used containing from 0.11% by weight to 1.02% by weight of solid MelPers TP 4335 (as component I) and from 0.05% by weight to 0.2% by weight of solid MelVis STAB TP 13/015 (as component II). The iron oxides used were of the haematite, goethite and magnetite type and the blends thereof. The dispersions prepared in accordance with the guide formulations of Table I are stable in storage for 6 months. The guide formulations were prepared by dissolver dispersion (20 minutes at 3,500 rpm).

TABLE 1
(iron oxide dispersions):

| Details in | Bayferrox | Bayferrox | Bayferrox | Ferroxon | Ferroxon | Ferroxon |
|---|---|---|---|---|---|---|
| % by weight | 110 | 920 | 318 | 430 | 422 | 510 |
| Water | 32.40 | 46.20 | 39.00 | 32.10 | 32.10 | 46.15 |
| NaOH, 50% | 0.20 | 0.30 | 0.20 | 0.40 | 0.40 | 0.50 |
| Defoaming | 0.20 | 0.20 | 0.20 | 0.20 | 0.20 | 0.20 |
| agent¹⁾ | | | | | | |
| Preservative²⁾ | 0.20 | 0.20 | 0.20 | 0.20 | 0.20 | 0.20 |
| MelVis STAB | 0.10 | 0.20 | 0.05 | 0.20 | 0.20 | 0.05 |
| TP 13/015³⁾ | | | | | | |
| MelPers TP | 1.90 | 2.90 | 0.35 | 1.90 | 1.90 | 2.90 |
| 4335⁴⁾ | | | | | | |
| Pigment⁵⁾ | 65.00 | 50.00 | 60.00 | 65.00 | 65.00 | 50.00 |
| Total | 100.00 | 100.00 | 100.00 | 100.00 | 100.00 | 100.00 |
| pH⁶⁾ | 8.5-10 | 8.5-10 | 8.5-10 | 8.5-10 | 8.5-10 | 8.5-10 |
| Viscosity | 1,000-1,500 | 800-1,200 | 1,200-1,700 | 800-1,200 | 800-1,200 | 1,000-1,500 |
| [mPas]⁷⁾ | | | | | | |

¹⁾Defoaming agent: typical millbase defoaming agent, for example TEGO Foamex 810 (Tego Chemie Service GmbH)
²⁾Pot preservation: as specified by the pigment manufacturer, for example Acetide MBS (THOR GmbH)
³⁾Corresponding to component II, 100% solid (Degussa Construction Polymers GmbH)
⁴⁾Corresponding to component I, 35% solid formulation in water (Degussa Construction Polymers GmbH)
⁵⁾Corresponding pigment from Bayer (Bayferrox) and Schlieper & Heyng (Ferroxon)
⁶⁾Recommended pH (23° C.)
⁷⁾Recommended viscosity range of the fresh dispersion, Brookfield, 23° C., spindle R2/R3, 50 rpm

The typical viscosity characteristic from fresh to matured dispersion is shown in Diagram 1 with reference to two of the aforementioned guide formulations of Bayferrox 110 and 920 respectively:

[image]

The rheological profile of the dispersions displays structurally viscous (viscosity decreases as shear rate increases) to slightly thixotropic (differing viscosity characteristic for rising and falling shear rates) properties. The extent of the shear stress corresponds substantially to the solids content of each dispersion (cf. Diagram 2 with reference to two of the aforementioned guide formulations of Bayferrox 110 and 920 respectively).

Diagram 2 (viscosity (black) and shear stress (grey) as a function of 1. rising—closed symbols—and 2. falling—open symbols—shear rates):

[image]

b) For dispersion of titanium dioxides, the pigment-based mixture of from 0.1% by weight to 10% by weight of solid MelPers 9360 (as component I) and from 0.005% by weight to 0.5% by weight of MelVis STAB 2344 (as component II) was used. There were obtained monodisperse, highly filled dispersions which have long-term stability, are free from reagglomerations and therefore satisfy the most stringent visual requirements. It is immaterial whether use is made of rutile-type titanium dioxides for direct grinding (Example A) or pigment paste preparations (Example B) for, for example, the formulation of dyes and paints or of anatase-type titanium dioxides (Example C) for, for example, the dulling of paper-coating slips. The preparation process (sulphate or chloride process) and the surface treatment (aluminium/zirconium/silicon oxides/organic) of the pigment are also irrelevant to the stability and performance of the titanium dioxide dispersion obtained. The guide formulations listed in Table 2 are prepared by dissolver dispersion (20 minutes at 3,500 rpm). Subsequent grinding of Examples A and B in a bead mill (30 minutes, ⅔ dispersion, ⅓ beads, 5,000 rpm) ensures optimum gloss and maximum covering power.

TABLE 2
(Titanium dioxide dispersions):

| Details in | | | |
|---|---|---|---|
| % by weight | A⁸ | B | C |
| Water | 28.80-28.20 | 22.94-19.90 | 45.24 |
| NaOH, 50% | 0.10 | 0.10 | 0.05 |
| Defoaming | 0.50 | 1.00 | 0.50 |
| agent¹ | | | |
| Preservative² | | 0.20 | |
| MelVis STAB | 0.10-0.20 | 0.01-0.05 | 0.01 |
| TP 2344³ | | | |
| MelPers 9360⁴ | 0.50-1.00 | 5.75-8.75 | 4.20 |
| (product) | | | |
| Pigment⁵ | 70.00 | 7000 | 70.00 |
| Total | 100.00 | 100.00 | 100.00 |

| | |
|---|---|
| pH⁶ | 8.0-9.0 |
| Viscosity⁷[mPas] | 800-2000 |

¹Defoaming agent: typical millbase defoaming agent, for example TEGO Foamex 810 (Tego Chemie Service GmbH)
²Pot preservation: as specified by the pigment manufacturer, for example Acetide MBS (THOR GmbH)
³Corresponding to component II, 100% solid (Degussa Construction Polymers GmbH)
⁴Corresponding to component I, 60% solid formulation in water (Degussa Construction Polymers GmbH)
⁵Corresponding rutile-type pigment (for A and B) for example Tioxide TR 92 (Huntsman), Kemira 660 (Kemira), Kronos 2190 (Kronos), Ti-Pure R-706 (DuPont), or Anastase-type (for C) for example Kronos 1077 (Kronos).
⁶Recommended pH (23° C.)
⁷Recommended viscosity range of the fresh dispersion, Brookfield, 23° C., spindle R2/R3, 50 rpm
⁸Exemplary formulation for immediate further processing in a paint (painting-on); for example 30% in Neocryl XK 90 (DSM/NeoResins).

Diagram 3 shows the effectiveness of the dispersion of titanium dioxide pigments (Examples A and B).

[image]

Diagram 4 shows the rheological profile of a pigment paste (70% Tioxide TR 92/8.75% MelPers 9360/0.01% MelVis STAB TP 2344) having long-term stability. The pigment paste is low-viscosity, slightly pseudoplastic and thixotropic (closed symbols=shear rate rising; open symbols=shear rate falling).

[image]

c) Pigment dispersions for transparent coatings (titanium dioxide), building material dyes (Spezialschwarz 100) and special printing inks (Hostaperm Rt, Spezialschwarz 250) can also be formulated in combination with components I and II. The dispersions are stable in storage for at least 3 months and they have a pH of between 6.5 and 8.5 over a viscosity of between 800 and 1,200 mPas (Brookfield, 23° C., spindle R3/R3, 20 rpm):
50% by weight of titanium dioxide P25 (Degussa AG) with 2.00% by weight of solid MelPers TP 3440Na (as component I) and 0.20% by weight of solid MelVis STAB TP 2344 (as component II).
35% by weight of Hostaperm Rot E3B (BASF) with 10.50% by weight of solid MelPers 9560 (as component I) and 0.20% by weight of solid MelVis STAB TP 1282 (as component II).
35% by weight of Spezialschwarz 100 (Degussa AG) with 2.45% by weight of solid MelPers TP 9360DEA (as component 1) and 0.10% by weight of solid MelVis STAB 13/015 (as component II).
35% by weight of Spezialschwarz 250 (Degussa AG) with 2.45% by weight of solid MelPers 9560 (as component I) and 0.10% by weight of solid MelVis STAB TP 13/015 (as component II).

For the use of the pigment dispersions as, for example, building material dyes, the lower case pH of the mixture was adapted accordingly to 8-10. A millbase defoaming agent was added to the carbon blacks (generally 0.2-0.5% of the total formulation, for example TEGO Foamex 810—Tego Chemie Service GmbH) during and after dispersion for effective defoaming. Pot preservation of the pigment pastes was carried out for reliable stability in storage. The mixture was first predispersed for 20 min at 3,500 rpm and then fully dispersed for 30 minutes in a beadmill (⅔ dispersion; ⅓ beads) at 5,000 rpm.

d) Fillers: filler dispersions for fire protection (Apyral 60), printing inks (Ultrafine ASP), ceramics, building materials and fire resistant materials (A-GK barium carbonate) and sol-gel dip coatings (Aerosil OX 50) can be formulated for a shelf life at least 3 months by combining component I and component II using a dissolver (20 minutes, 3,500 rpm):
60% by weight of Apyral 60 (Nabaltec) with 1.80% by weight of solid MelPers 2450 (as component I) and 0.30% by weight of solid MelVis STAB TP 1282 (as component II); pH=7.5-8.5; viscosity (Brookfield, 23° C., spindle R2/R3, 50 rpm)=800-1,500 mPas.
60% by weight of (Ultrafine ASP (Engelhard Corp.) with 1.80% by weight of solid MelPers 3400 (as component I) and 0.10% by weight of solid (Mel Vis STAB TP 2344 (as component II); pH=4.5-5.5; viscosity (Brookfield, 23° C., spindle R2/R3, 50 rpm)=800-1,500 mPas.
70% by weight of barium carbonate A-GK (Solvay Barium Strontium) with 0.14% by weight MelPers 9360 (as component 1) and 0.15% by weight of solid MelVis STAB TP 13/015 (as component II); pH=8.0-9.5; viscosity (Brookfield, 23° C., spindle R2/R3, 20 rpm)=800-1,500 mPas.
50% by weight Aerosil OX 50 (Degussa) with 0.15% by weight of solid MelPers TP 3440A (as component I) and 0.15% by weight of solid Mel Vis STAB TP 2344 (as component II); pH=8.5-9.5; viscosity (Brookfield, 23° C., spindle R2/R3, 20 rpm)=600-1000 mPas.

A millbase defoamer (for example TEGO Foamex 810—Tego Chemie Service GmbH) was used, as required, during and after dispersion for effective defoaming (generally 0.2-0.5% by weight of the total formulation). Pot conservation of the filler pastes was carried out for reliable stability in storage.

### 2. Casein Substitutes

Exemplary Applications

Melflux® 1641F and 2651F (from Degussa Construction Polymers GmbH) are PCE-based flow promoters corresponding to component I of the invention.
Starvis® 4302F and 3003F (from Degussa Construction Polymers GmbH) are stabilisers corresponding to component II of the invention.

a) Test Formulation

| Component | Content (% by weight) |
|---|---|
| OPC (CEM I 42.5 R) | 18.500 |
| CAC (70% CA) | 11.500 |
| CaSO₄ (synthetic anhydrite) | 6.500 |
| Silica sand | 40.615-40.765 |
| Limestone powder | 19.400 |
| Latex powder | 2.000 |
| Component II (Stands 3003F or 4302F) | 0.05-0.20 |
| Li₂CO₃ | 0.100 |
| Defoamer | 0.150 |
| Tartaric acid | 0.035 |
| Citric acid | 0.150 |
| Shrinkage reducing agent | 0.600 |
| Component I (Melflux 2651F) (alternatively: | 0.250 |
| Melflux 1461F + K, sodium tartrate) | (0.400) |
| Dry mortar mix (total) | 100.000 |
| Water | 20.000 |

b) Mortar Properties

amount added and influence of the stabiliser component

| | | | | | | | | | No bleeding, | | | | | | | | |
|---|---|---|---|---|---|---|---|---|---|---|---|---|---|---|---|---|---|
| | | | Bleeding | | | Slight bleeding | | | good flow | | | No flow | | | | | |
| | | | [symbol] Stabilising amount → | | | | | | | | | | | | | | |
| Dispersant | Retardant | Stabiliser | 0.01 | 0.02 | 0.03 | 0.04 | 0.05 | 0.06 | 0.07 | 0.08 | 0.09 | 0.10 | 0.11 | 0.12 | 0.13 | 0.14 | 0.15 |
| Casein | Tartrate | CE | | | | | | | | | | | | | | | |
| PCE | Tartrate | CE | | | | | | | | | | | | | | | |
| PCE | Tartrate | Starvis 3003F | | | | | | | | | | | | | | | |
| PCE | Tartrate | Starvis 4302F | | | | | | | | | | | | | | | |
| Melflux | Citric acid | Starvis 3003F | | | | | | | | | | | | | | | |
| 2651F | | | | | | | | | | | | | | | | | |
| Melflux | Citric acid | Starvis 4302F | | | | | | | | | | | | | | | |
| 2651F | | | | | | | | | | | | | | | | | |

PCE: Polycarboxylate ether;
CE: Celluose ether

Results:

| | |
|---|---|
| Casein: | 0.30 to 0.40% btw |
| CE: | 0.05 to 0.10% btw |

Large amounts of dispersing agent; narrow effective range of the stabiliser

| | |
|---|---|
| Polycarboxylate Ether: | 0.30 to 0.40% btw |
| CE: | 0.09 to 0.10% btw |

Large amounts of dispersing agent, very narrow effective range of the stabiliser

| | |
|---|---|
| Melflux 2651F: | 0.10 to 0.30% btw |
| Starvis 3003F or Starvis 4302F: | 0.05 to 0.20% btw |

Small amounts of dispersing agent; broad effective range of the stabiliser
The evaluation criterion was a levelling of >14.5 cm and no bleeding

Water tolerance; antisedimentation and bleeding properties

Casein (0.30-40%)+cellulose ether (0.05-0.10%)

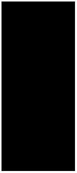

Given in each case are the amounts of water in % by weight based on the dry mortar mix.

Polycarboxylate ether (0.30-0.40%)+cellulose ether (0.09-0.10%)

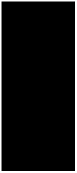

Given in each case are the amounts of water in % by weight based on the dry mortar mix.

Melflux® 2651 F (0.10-0.30%)+Starvis® 3003 F or 4302 F (0.05-0.20%)

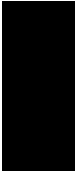

Given in each case are the amounts of water in % by weight based on the dry mortar mix.

Evaluation Criteria

Bleeding and sedimentation
Slight bleeding
No bleeding; (flow≧14.5 cm) no sedimentation
No flow (flow<14.5 cm)
Mixing process

A sample was taken and the flow determined every 15 sec during mixing. At 90 sec, the mixing time required for casein-based formulations was approx. 3 times longer than for formulations comprising components I and II (Melflux® 2651 F, Starvis 3003 F and 4302 F) (30 sec).

| Total time | Process steps (EN 1937) | Time required |
|---|---|---|
| 0′00″-0′30″ | Powder added to water | 0″ |
| 0′30″-0′45″ | Mixing (140 rpm) | 15″ |
| 0′45″-1′00″ | Cleaning of container and stirrer; | 15″ |
| | First levelling sample | |
| 1′00″-1′15″ | Mixing (285 rpm) | 30″ |
| 1′15″-1′30″ | Levelling test | 30″ |
| Then | Sample taken every 15 sec | etc. |
| | Mixing for further 15 sec | |

[image]

Results:

Levelling properties are dependent mainly on stiffening the binder component in good time. The thixotropic effects of the stabiliser are reduced to a minimum. As no changes in the slump were observed within the measured period of time, the flow properties of the stable mortars were not influenced by the stabiliser component.

Even in the case of low contents of Melflux 2651F as component 1 (0.25% by weight), the levelling properties are greatly improved over the casein-based formulations.
Self-healing properties

These were tested using the knife-cut test* corresponding to a seven-stage evaluation scale: (* knife-cut test=the surface of the poured-out material is breached and the “self-healing”, i.e. the reconvergence, evaluated).

[image]

| | 8 min | 15 min | 30 min | 45 min | 60 min |
|---|---|---|---|---|---|
| Casein/cellulose ether | 1 | 1 | 2 | 3 | 5 |
| PCE/cellulose ether | 1 | 1 | 2 | 3 | 5 |
| Melflux 2651F/ | 1 | 1 | 2 | 2 | 4 |
| Starvis 3003F | | | | | |
| Melflux 2651F/ | 1 | 1 | 2 | 2 | 4 |
| Starvis 4302F | | | | | |

[image]

The retarding effects of casein and cellulose ether (comparison) were fully compensated by the combination of Melflux 2651 F and Starvis 3003F (invention) or 4302F.

C) Properties in the Cured State

Compressive strength

The compressive strength was determined using prisms (4×4×16 cm³).

[image]

The combined use of Melflux® 2651F and Starvis® 3003F or 43002F leads to marked early strength (after 4 hours) compared to casein and cellulose ether-containing mortars. It also facilitates easier accessibility and earlier application of coatings/linings.

Flexural tensile strength

The bending and tensile strength was determined using prisms (4×4×16 cm³).

[image]

1-35. (canceled)

36. A mixture composition having a dispersing effect comprising
I) a copolymer based on unsaturated mono or dicarboxylic acid derivatives and oxyalkylene glycol alkenyl ethers; and
II) at least one of a water-soluble copolymer or terpolymer containing sulpho groups and having a number average molecular weight of from 50,000 to 20,000,000 g/mol, wherein component I) comprises
a) from 51 to 95 mol % of the structural groups of at least one of formula Ia, Ib or Ic 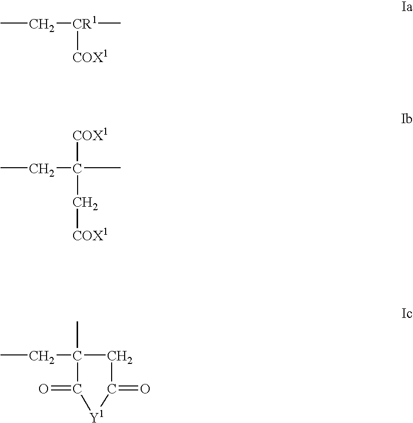
wherein
R¹ is hydrogen or an aliphatic hydrocarbon radical comprising from 1 to 20 carbon atoms;
X¹ is OMₐ¹, —O—(CₘH₂ₘO)—R², —NH—(CₘH₂ₘO)ₙ—R²;
M¹ is hydrogen, a monovalent or divalent metal cation, ammonium ion, or an organic amine radical;
a is ½ or 1
R² is hydrogen, an aliphatic hydrocarbon radical comprising from 1 to 20 carbon atoms, a cycloaliphatic hydrocarbon radical comprising from 5 to 8 carbon atoms, or an optionally substituted aryl radical comprising from 6 to 14 carbon atoms;
Y¹ is O or NR²;
m is from 2 to 4; and
n is from 0 to 200;
b) from 1 to 48.9 mol % of the structural group of formula II 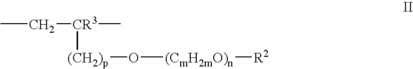
wherein R³ is hydrogen or an aliphatic hydrocarbon radical containing 1 to 5 carbon atoms;
p is from 0 to 3; and
R², m and n are as defined above;
c) from 0.1 to 5 mol % of the structural groups of at least one of formula IIIa or IIIb 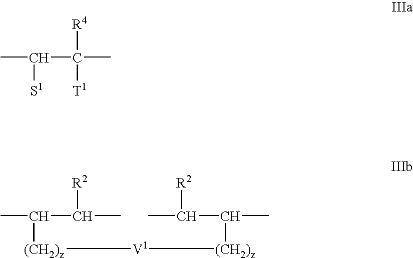
wherein
S¹ is —H, —COOMₐ¹, —COOR⁵;
T¹ is —U¹—(CH—CH₂—O)ₓ—(CH₂—CH₂—O)_{y}—R⁶
CH₃
—W¹—R⁷
—CO—[NH—(CH₂)₃]_{z}—W¹—R⁷
—CO—O—(CH₂)_{z}—W¹—R⁷
—(CH₂)_{z}—V¹—(CH₂)_{z}—CH═CH—R²
COOR⁵ if S¹ is COOR⁵ or COO₂Mₐ¹;
U¹ is —CO—NH—, —O— or —CH₂O—;
U² is —NH—CO—, —O— or —OCH₂—;
V¹ is —O—CO—C₆H₄—CO—O— or —W¹— wherein 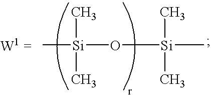
R⁴ is H or CH₃
R⁵ is an aliphatic hydrocarbon radical comprising from 3 to 20 carbon atoms, a cycloaliphatic hydrocarbon radical containing 5 to 8 carbon atoms, or an aryl radical containing 6 to 14 carbon atoms;
R⁶ is R², 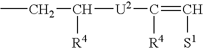
R⁷ is R², 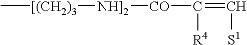
r is from 2 to 100
s is 1 or 2;
z is from 0 to 4;
x is from 1 to 150;
y is from 0 to 15;
and
d) from 0 to 47.9 mol % of the structural groups of at least one of formula IVa or IVb 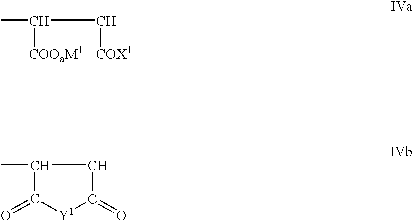
wherein a, M¹, X¹ and Y¹ are as defined above.

37. A mixture composition according claim 36, wherein component II comprises at least one of
a) from 3 to 96 mol % of the structural groups of formula (V) 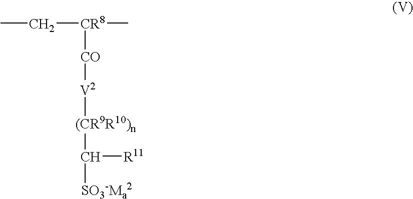
wherein R⁸ is hydrogen or methyl;
R⁹, R¹⁰, R¹¹ are independently selected from hydrogen, aliphatic hydrocarbon radical containing 1 to 6 carbon atoms, and phenyl radical optionally substituted by methyl groups;
V² is NH or oxygen;
M² is hydrogen, a monovalent or divalent metal cation, ammonium or an organic amine radical;
N is from 1 to 5;
a is 2 or 1;
b) from 3 to 96 mol % of at least one of the structural groups of formula VIa and VIb 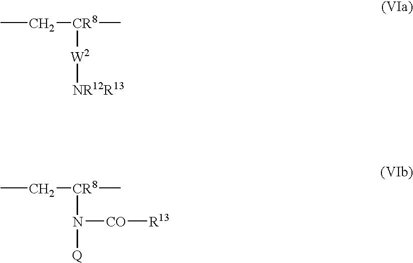
wherein W² is —CO—, —CO(O)—(CH₂)ₓ— or —CO—NR⁹—(CH₂)ₓ—;
x is from 1 to 6;
R¹² and R¹³ are independently selected from hydrogen, an optionally substituted aliphatic hydrocarbon radical containing 1 to 20 carbon atoms, a cycloaliphatic hydrocarbon radical containing 5 to 8 carbon atoms or an aryl radical containing 6 to 14 carbon atoms; and
Q is hydrogen and —CHR¹²R¹⁴, wherein
if Q is H, R¹² and R¹³ in VIb, together form a —CH₂—(CH₂)_{y} methylene
group wherein y is from 1 to 4, R¹⁴ is hydrogen, an aliphatic hydrocarbon radical containing 1 to 4 carbon atoms, —COOH or —COOM²ₐ; and
R⁸, R⁹, M² are as defined above,
and
c) up to 75 mol % of the structural groups of at least one of formula VIIa or VIIb 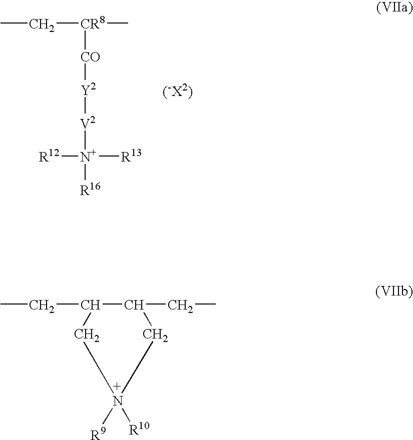
wherein Y² is O, NH or NR¹²,
V² is —(CH₂)ₓ—, 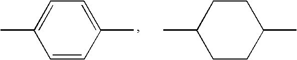
R¹⁵ is R¹² or R¹³, —(CH₂)ₓ—SO₃M²ₐ 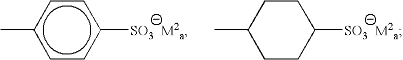
X² is halogen, a C₁ to C₄ alkyl sulphate or a C₁ to C₄ alkyl sulphonate;
d) or up to 50 mol % of the structural groups of formula (VIII) 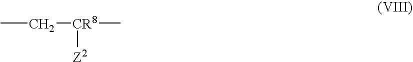
wherein
Z²=—COO(CₘH₂ₘO)ₙ—R¹⁶, —(CH₂)ₚ—O(CH₂CHW³O)ᵣ—(CₘH₂ₘO)ₙ—R¹⁶
W³=H, CH₃, C₂H₅,
r is from 0 to 100
R¹⁶ is H, or 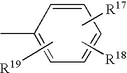
wherein at least one radical R¹⁷, R¹⁸ or R¹⁹ must be represented, and a saturated or unsaturated, linear or branched, aliphatic hydrocarbon radical containing 1 to 40 carbon atoms
R¹⁷ is H, C₁-C₄ alkyl, phenyl, benzyl, C₁-C₄ alkoxy, halogen, cyano, —COOH, —COOR¹², —CO—NH₂, or —OCOR¹²;
R¹⁸ is an arylalkyl group containing a C₁-C₁₂ alkyl and C₆-C₁₄ aryl radical;
R¹⁹ is an alkylaryl group containing a C₁-C₁₂ alkyl and C₆-C₁₄ aryl radical;
m is from 2 to 4;
n is from 0 to 200;
p is from 0 to 10;
and R⁸ and R¹² are as defined above.

38. A mixture composition according to claim 36, containing component I in a proportion of from 0.05 to 50% by weight as a solid and component II in a proportions of from 0.01 to 10% by weight as a solid.

39. A mixture composition according to claim 36, wherein in component I R¹ is a methyl radical.

40. A mixture composition according to claim 36, wherein in component 1 M¹ is a monovalent or divalent metal cation selected from the group consisting of sodium, potassium, calcium and magnesium.

41. A mixture composition according to claim 36, wherein in component I if R₂ is phenyl, the phenyl radical is also substituted by hydroxyl, carboxyl or sulphonic acid groups.

42. A mixture composition according to claim 36, wherein in component I, in formula II, p is 0 or 1 and m is 2.

43. A mixture composition according claim 36, wherein component I contains from 55 to 75 mol % of the structural groups of at least one of formula Ia, Ib or Ic, from 19.5 to 39.5 mol % of the structural groups of formula II, from 0.5 to 2 mol % of the structural groups of at least one of formula IIIa or IIIb, and from 5 to 20 mol % of the structural groups of at least one of formula IVa or IVb.

44. A mixture composition according to claim 36, wherein component I additionally contains up to 50 mol %, in particular up to 20 mol %, based on the total of the structural groups of formulae I, II, III and IV, of structural groups, the monomer of which is a vinyl or (meth)acrylic acid derivative.

45. A mixture composition according to claim 44, wherein the monomeric vinyl derivative is styrene, α-methyl styrene, vinyl acetate, vinyl propionate, ethylene, propylene, isobutene, N-vinyl pyrrolidone, allyl sulphonic acid, methallyl sulphonic acid, vinyl sulphonic acid or vinyl phosphonic acid.

46. A mixture composition according to claim 44, wherein the monomeric (meth)acrylic acid derivative is hydroxyalkyl(meth)acrylate, acrylamide, methacrylamide, AMPS, methyl methacrylate, methyl acrylate, butyl acrylate or cyclohexyl acrylate.

47. A mixture composition according to claim 36, wherein component I has an average molecular weight of from 1,000 to 200,000 g/mol.

48. A mixture composition according to claim 36, wherein in component II the monovalent or divalent cation is a sodium, potassium, calcium or magnesium ion and X is chlorine, bromine, sulphate or methyl sulphate.

49. A mixture composition according to claim 36, wherein in component II structural group a) comprises 2-acrylamido-2-methyl propane sulphonic acid (AMPS) or a salt thereof.

50. A mixture composition according to claim 36, wherein in component II up to 50 mol % of structural groups a), b) or c) are replaced by structural units derived from acrylamide or N,N-dimethylacrylamide monomers.

51. A mixture composition according to claim 36, wherein in component II up to 50 mol % of structural groups a) are replaced by other sulpho group-containing structural units derived from methallyl sulphonic acid or allyl sulphonic acid monomers.

52. A mixture composition according to claim 36, wherein in component II the organic amine radicals are preferably substituted ammonium groups derived from primary, secondary or tertiary C₁ to C₂₀ alkylamines, C₁ to C₂₀ alkanolamines, C₅ to C₈ cycloalkylamines and C₆ to C₁₄ arylamines.

53. A mixture composition according to claim 36, wherein in component H the hydrocarbon or aryl radicals of R¹² and R¹³ are also substituted by hydroxyl, carboxyl or sulphonic acid groups.

54. A mixture composition according to claim 36, wherein component II consists of from 30 to 80 mol % of structural group a), from 5 to 55 mol % of structural group b), from 2 to 30 mol % of structural group c) and/or from 0.2 to 15 mol % of structural group d).

55. A mixture composition according to claim 36, wherein in component II the molar content of structural group c) is at least 5 mol % lower than the molar content of structural group a).

56. A mixture composition according to claim 36, wherein component II has a number average molecular weight of from 50,000 to 10,000,000 g/mol.

57. A mixture composition according to claim 36, wherein component II further comprises from 0.0001 to 50 mol % of structural groups e) derived from polymerizable at least one of a monoolefinic, a diolefinic or a triolefinic compound.

58. A mixture composition according to claim 57, wherein the diolefinic compounds comprise diacrylate or dimethylacrylate esters.

59. A mixture composition according to claim 57, wherein the triolefinic monomers are trimethylolpropane triacrylate or triallyl isocyanurate.

60. A mixture composition according to claim 57, wherein the monoolefinic compounds are at least one of an acrylic or a vinyl derivative.

61. A mixture composition according to claim 36, wherein components II, comprising at least one of the structural groups a), b), c) or d), also contain up to 50 mol %, in particular up to 20 mol %, based on the total of structural groups a), b), c) and d), of a further structural group f) of formula (IX) 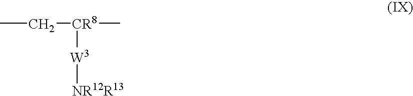
wherein
W⁴ is from —CO—O—(CH₂)_{q}—, CO—NR⁹—(CH₂)_{q}—;
q is from 1 to 6;
R⁸, R⁹, R¹² and R¹³ are as defined above.

62. A mixture composition according to claim 36, wherein up to 50% of structural group a) of component II is replaced by building block g) according to formula (X) derived from sulphonic acid-containing betaine monomers 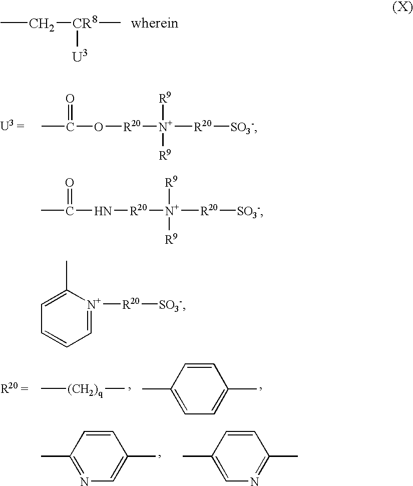
and
R⁸, R⁹ and q have the meaning given above

63. A mixture composition according to claim 36, wherein components II also comprise up to 0.1 mol % based on the respective totals of structural groups a), b), c), d), e), f) and g) of a cross-linking agent component selected from the group consisting of triallylamine, triallymethylammonium chloride, tetraalkylammonium chloride, N,N′-methylene-bis-acrylamide, triethylene-glycol-bis-methacrylate, triethylene-glycol-bis-acrylate, polyethylene-glycol(400)-bis-methacrylate and polyethylene-glycol(400)-bis-acrylate.

64. A mixture composition according to claim 36, comprising components I and II in premixed form.

65. A mixture composition according to claim 36, wherein it is present in viscous and particularly preferably in fluid form.

66. A mixture composition according to claim 36, containing at least one of organic or inorganic pigments and fillers.

67. A composition comprising the mixture composition according to claim 36 and a hydraulic binder.

68. A composition comprising the mixture composition according to claim 36 and a ceramic system or a water-based painting and coating systems.

69. A composition comprising of claim 68, wherein the mixture composition is a plasticizer having a simultaneous stabilizing effect.

70. A self-levelling levelling material or filler comprising the mixture composition of claim 36.
